(19) United States
(12) Patent Application Publication
(10) Pub. No.: US 2008/0207075 A1
(43) Pub. Date: Aug. 28, 2008

(54) Optimized fabric lay-up for improved ceramic matrix composites

(75) Inventors: Gary B. Merrill, Orlando, FL (US); Jay E. Lane, Mims, FL (US)

Correspondence Address: Siemens Corporation;Intellectual Property Department, 170 Wood Avenue South, Iselin, NJ, 08830, US

(73) Assignee: Siemens Power Generation, Inc.

(21) Appl. No.: 11/709,699

(22) Filed: Feb. 22, 2007

(51) Int. Cl. B32B 18/00

(52) U.S. Cl. 442/262

(57) ABSTRACT

A ceramic matrix composite (CMC) is constructed from ceramic fabric sheets and a ceramic matrix to yield matrix rich zone of reduced dimensions between fabric sheets. This reduction in dimension decreases the occurrence of delamination between the fabric sheets. The fabric is optimized to reduce the size of matrix rich zones in the composite by increasing the number of fabric plies in a given thickness of composite.

### FIELD OF THE INVENTION

The invention is directed to preparing ceramic matrix composites with improved interlaminar properties.

### BACKGROUND OF THE INVENTION

The use of ceramic matrix composites (CMC) is necessary to achieve higher efficiency gas turbine engines and other applications where higher working temperatures are required. Although CMC materials can withstand the high temperatures, these materials have shortcomings resulting from the nature of the fabrication process, as there are structural changes in the matrix during curing of the composite. This shortcoming is primarily the formation of cracks that can ultimately lead to delamination failure under stress.

CMCs are constructed by the lamination of a plurality of fabric sheets and the failure is primarily interlaminar. This interlaminar failure occurs in the band of matrix rich material between the fabric sheets. After the fabrics are impregnated with matrix material, the fabrics are layed-up, compressed, and the matrix is dried and sintered to develop a continuous composite. The drying and sintering processes results in shrinkage in the matrix. This shrinkage results in cracks. Subsequent thermal cycling of the article under mechanical stress can result in crack propagation and ultimately failure in the matrix.

Presently, the commercially available fabrics for high temperature oxide CMC construction are limited to sheets with 1500 and 3000 denier tows of alumina fibers. FIG. 1 illustrates the lay-up of four fabric sheets with 3000 denier tows 5 and 6 with shrinkage induced cracks within the matrix rich zone 7 of the interlaminar region. The cracks can be cracks 9 that are primarily normal to the fabric sheets and cracks 8 that are primarily parallel to the fabric sheets. Cracks 9 normal to the fabric sheets have a limited ability to propagate because the fibers in the tows adjacent fabric sheets act as a site to terminate crack propagation. Furthermore, failure does not result from these normal cracks 9 as the strength of the CMC article in the dimensions parallel to the fabric sheets are defined by the strength of the fibers and is generally several orders of magnitude greater than that of the matrix material. Hence cracks 9 normal to the fabric sheets cause no significant decrease in the strength of the composite. This is not the case for cracks 8 that form parallel to the fabric sheets in the interlaminar region. In this case the cracks parallel to the fabric sheets are less likely to encounter fibers of the tows resulting in termination of crack propagation. Interlaminar failure can result after sufficient crack propagation, since there is no fiber reinforcement in the direction normal to the fabric sheets. Interlaminar failure is the primary mode of failure for CMC articles.

Although an improved matrix zone structure is a desirable goal, no suitable material has been identified that improves the resistance of the matrix to crack formation or propagation that has the required thermal properties. The improvement of composite properties has also been explored by improving the composite architecture.

An improvement of the interlaminar strength has been attempted by the inclusion of small non-woven fibers perpendicular to the sheets of the fabric as disclosed in Kostar et al. U.S. Patent Application Publication 2005/0186878. However this approach requires additional processing steps.

Another approach to improving the interlaminar strength is to diminish the inherent porosity of the matrix of the CMC. Lange et al., U.S. Pat. No. 5,856,252 discloses the densification of the matrix by including multiple matrix precursor infusion and pyrolysis steps into the process. Alternately, Kameda et al., U.S. Pat. No. 5,939,216 discloses an alternate route to densification of the matrix by including a series of infusions and reactive formations of matrix material. An improvement that does not further complicate the composite construction process is needed.

Recently, laboratory experiments with unidirectional tape lay-ups have yielded an improved homogeneity where the critical flaw size is reduced and a strong composite resulted that resists delamination. Although a unidirectional tape composite is reinforced by the tape only in one-dimension, and as such is not appropriate for most of the CMC applications, these results indicate that an improvement in homogeneity can improve the strength of a composite.

### SUMMARY OF THE INVENTION

A ceramic matrix composite (CMC) with improved resistance to delamination comprises two or more stacked woven ceramic fabric sheets and two or more ceramic matrix rich zones disposed between the fabric sheets where the critical flaw size of the matrix rich zone is less than 200 μm. It is preferable to have fabric, when constructed with alumina tows, that are equal to or less than 1200 denier. It is preferable to have seven to fifteen sheets of fabric per millimeter of composite. It is also preferable that the tows have loosely compacted fibers such that the fibers constitute 30 to 60% of the volume of the tow. The fabric sheets can have a tow width-to-spacing ratio of 1 to 10. The width-to-thickness ratio of the tows can be 3 to 20.

### BRIEF DESCRIPTION OF THE DRAWINGS

FIG. 1 is a prior art CMC constructed from a 3000 denier fabric where multiple orientations of adjacent fabrics display the variance and extremes of the possible matrix rich zones between fabric sheets.

FIG. 2 shows a CMC structure according to the invention.

FIG. 3 shows a CMC structure according to an alternative embodiment of the invention.

FIG. 4 shows a CMC structure according to yet another embodiment of the invention.

### DETAILED DESCRIPTION OF THE INVENTION

The unidirectional tape results demonstrated that an improvement in homogeneity of the fiber containing portion of the composite is possible and that increasing the homogeneity can reduce the matrix rich zone dimensions to a point that approaches or is below the critical dimensions for crack initiation. Any resulting cracks will be very small and below the size where delamination failure is promoted. The present invention achieves increased homogeneity by an increased partitioning of the fabric sheets such that the individual matrix rich zones between fabric sheets are reduced in dimension resulting in a limiting of the size of cracks and the microstructure of the matrix that significantly reducing the propensity of crack promoted delamination.

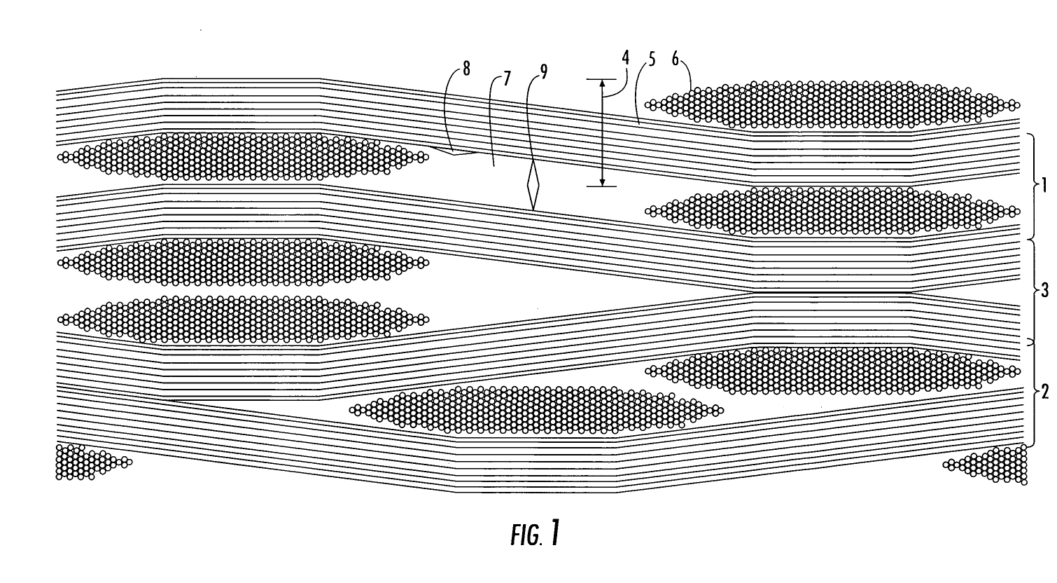

FIG. 1 illustrates the structure of a prior art composite with a commonly used 3000 denier fabric. This fabric has a thickness 4 of approximately 480 μm and warp 5 and fill (or weft) 6 thread counts of 9 tows/cm. When these layers of fabric are placed together such that contact is made between the sheets and with all warp threads parallel to each other, three discrete orientations can be considered that either minimize or maximize the dimensions of the matrix rich zones 7. The first orientation is where the warp and fill are in phase, orientation 1, a second orientation is where they are approximately 90° out of phase, orientation 2, and the third orientation is where they are 180° C. out of phase, orientation 3. Other orientations will have matrix rich volumes between the maximum and the minimum for these orientations. Although it is difficult and is generally not practical to align perfectly the fabric sheets such that all tows are oriented parallel or perpendicular to each other or to align them at a specific orientation, all orientations are not equally likely to delaminate. The orientation that is 90° out of phase has a matrix rich zone 7 between adjacent fabric sheets that is less likely to be of sufficient dimensions to permit crack initiation. Hence, to improve the interlaminar strength one must selectively reduce the matrix rich zone of the least favorable orientations, primarily by modifying the dimensions of the matrix rich zones normal to the fabric sheets. The critical flaw size of the matrix rich zone will be equal to or less than the thickness of the matrix rich zone which will be equal to or less than the thickness of the fabric. A fabric with a thickness equal to the desired critical flaw size is used to assure the achievement of the desired critical flaw size.

The available 3000 and 1500 denier alumina fabrics display ply thicknesses of approximately 480 and 280 μm. It is preferable to have a potential flaw size of less than 200 μm to achieve an increase in the interlaminar tensile strength. The interlaminar strength exhibited by a CMC prepared with 1500 denier fabric is about 5 MPa. Since the matrix is a brittle monolithic material, the strength is proportional to the inverse square root of the flaw size. The invention is directed to the increased partitioning of matrix rich zones to reduce the potential flaw size and therefore increases the strength of the CMC.

The present invention provides matrix rich zones within the CMC that are of a dimension such that matrix shrinkage induced cracking parallel to the fabric sheet surface is inherently small or non-existent. The volume of the individual matrix rich zones must be reduced. To achieve the matrix rich zone volume reduction, the number of fabric sheets must be increased for a given thickness of the CMC. To divide the matrix rich zone into zones of smaller dimensions and improve the strength, the composite of the invention includes a sufficiently greater number of sheets for a given thickness of composite than is possible with the fabric constructed from the commercially available fabrics from 3000 and 1500 denier tows that are described above. A composite with seven to fifteen or more sheets per millimeter is preferred to achieve a sufficiently small flaw size and lead to a significantly diminished cracking propensity of the matrix rich zones relative to CMCs presently available. To a first approximation, this cracking propensity decreases proportionally to the square root of the minimum inter-fiber distance from a fiber tow in one layer to the fiber tow in the adjacent layer. The strength improvement that is possible for the preferred range of sheets per millimeter, seven to fifteen per millimeter, is about 1.4 times to more than two times that available with commercially available 1500 denier fabric.

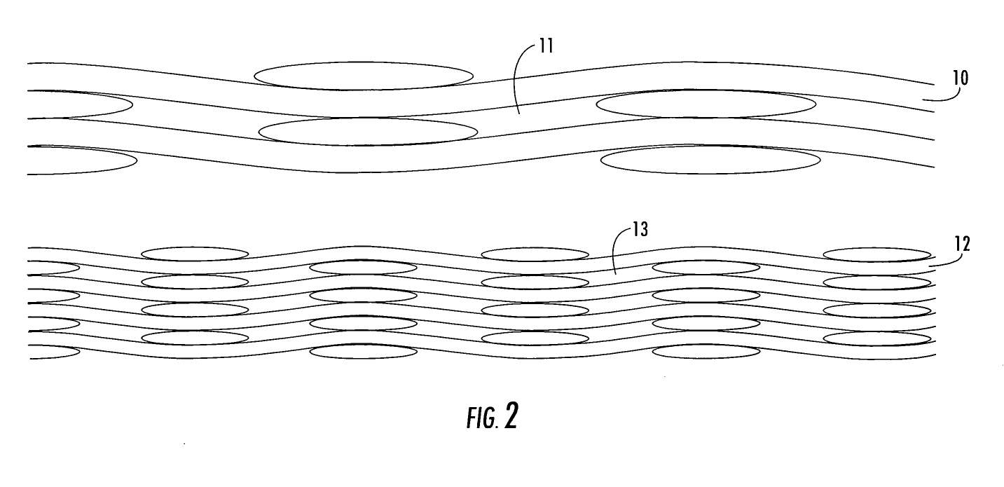

In one embodiment of the invention the greater number of fabric sheets per thickness is achieved by using alumina fabrics from tows of reduced denier. This embodiment is illustrated in FIG. 2 where one CMC is constructed from a fabric with a greater denier value tow 10 and another CMC is constructed of a tow 12 with a denier value of approximately half that of tow 10. Although not required for the invention, FIG. 2 shows fabrics where the thread count of the lesser denier fabric is increased proportionately to the denier decrease. Clearly by maintaining the same tow width-to-spacing ratio, the use of the fabric of lesser denier tows 12 has more matrix rich zones 13 than has a CMC constructed of a larger tow 10 in a given volume, but this increased partitioning results in zones of much smaller dimensions. The reduced dimensions of the matrix rich zones 13 for the CMC from tows 12 reduces the propensity for crack initiation during curing to approximately 1.4 that of the CMC from fabrics with tows 10. The probability of crack termination by encountering a fiber of a tow also increases proportionally to the surface area of fibers in a given volume of composite. This also improves the strength of a CMC from the fabrics with tows 12 over that from fabrics with tows 10. The ratio of tow width-to-spacing can vary and still be within the scope of the present invention. Other ceramic fabrics can be used and it should be understood that with similar dimensions of the tow the denier value will be different from that of alumina tows. The tow width-to-spacing between tows can be slightly less than one to more than ten, for example 0.8 to 15.

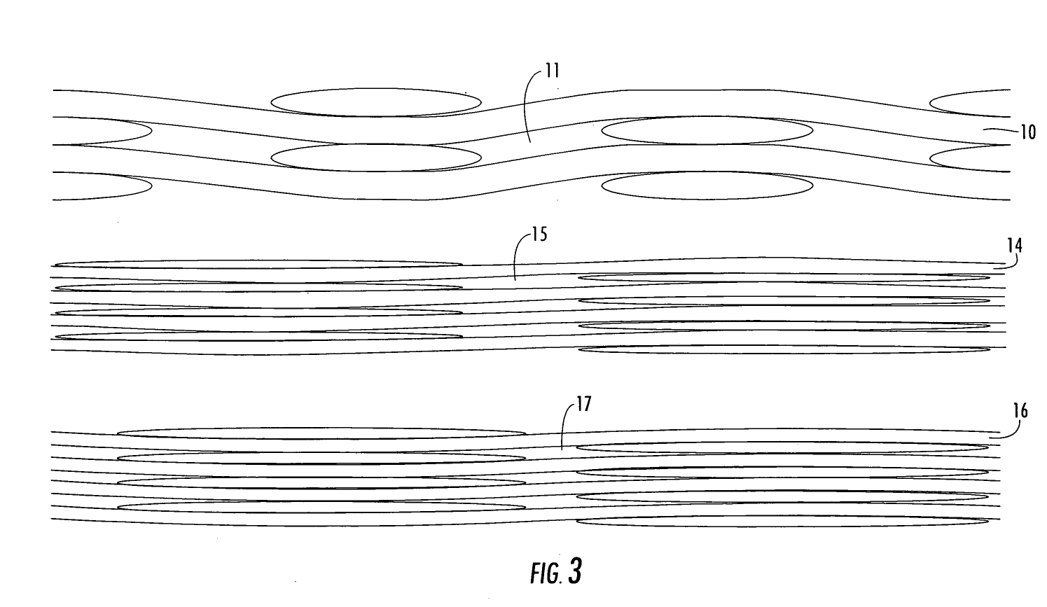

Another embodiment of the invention is the use of fabric constructed from tows where the ratio of width to thickness is large. For the same denier of fabric, the matrix rich zones between sheets constructed from these high width-to-thickness ratio tows will be significantly smaller in dimension than for those constructed from fabrics where the tows have a lesser width-to-thickness ratio. In this manner the needed seven to fifteen fabric sheets per millimeter thickness can be achieved when the denier of the tow is 1500 or greater. This difference is illustrated in FIG. 3 where it can be seen that the matrix rich zone 15 in a CMC prepared with fabric with a greater width-to-thickness ratio tow 14 is of smaller dimensions than the matrix rich zone 11 within a CMC prepared from a fabric with tows 10 of the same denier but of a lesser ratio of width-to-thickness. To illustrate the effect of varying the tow width-to-spacing ratio, FIG. 3 illustrates a CMC using a fabric with greater width-to-thickness ratio tows 14 and having spacing between tows that is comparable to the spacing between tows of the fabric from the lesser width-to-thickness ratio tows 10. In FIG. 3 the individual matrix rich zones 15 are of half the volume of the matrix rich zone 11. By further reducing the spacing between the lesser width-to-thickness ratio tows 16 the matrix rich zone 17 can be further reduced in volume to further reduce the critical flaw size. The ratio of width-to-thickness can be from about 3 to more than 20. The spacing between tows of the fabric can be equal to the width of the tow to less than 10% of the width of the tow, a width-to-spacing ratio of 1 to more than 10.

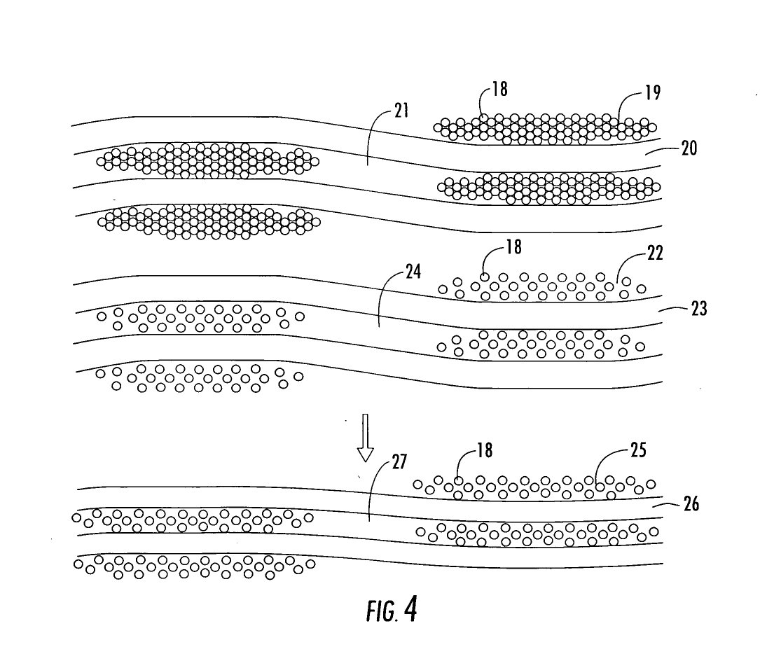

The homogeneity of the CMC is also improved by reducing the compactness of the fibers in the tows in the fabric. Presently available fabrics have tows where the fibers are tightly compacted. FIG. 4 shows a small portion of two CMC composites where the warp tow is illustrated as individual fibers 18 for a CMC from tightly compacted tows 19, top, and from loosely compacted tows 22 upon initial lay-up, center, and after compression to form the composite, bottom where the compactness of the tow 25 has been increased due to the compression. In FIG. 4 the loosely compacted warp tows 22 has half the number of fibers for the same tow volume as does the tightly compacted warp tow 19, shown for comparison. The compactness of the fill tows 20, 23, and 26 is not illustrated in FIG. 4 but will also contribute to the homogeneity of the composite by being more loosely compacted and compressed while forming the composite. The matrix rich zone 21 for the tightly compact tow is shown to be equal to the matrix rich zone 24 of the loosely compacted tow upon lay-up. Upon compression of the composite the matrix rich zone 27 is reduced in thickness and width as the tows 25 and 26 are compressed. This is the primary mode by which the use fabrics with loosely compacted tows permit the reduction in the volume of the matrix rich zone and the critical flaw size of the composite. The proportion of the loosely compacted tow 22 volume that is occupied by fibers is preferably 30 to 60%.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as described in the claims.

We claim:

1. A ceramic matrix composite (CMC) with improved resistance to delamination, comprising:
a plurality of stacked woven ceramic fabric sheets, and
a plurality of ceramic matrix rich zones disposed between said fabric sheets, wherein the critical flaw size of the matrix rich zone is less than 200 μm.

2. The CMC of claim 1, wherein said fabric has alumina tows of less than 1200 denier.

3. The CMC of claim 1, wherein seven to fifteen of said sheets are present per millimeter of composite thickness.

4. The CMC of claim 1, wherein said fabric sheets have loosely compacted tows wherein the volume of fibers is between 30 to 60% of the volume of said tow.

5. The CMC of claim 1, wherein said fabric sheet has a tow width-to-spacing between tow ratio of 1 to 10.

6. The CMC of claim 1, wherein the fabric sheet comprises tows with a width-to-thickness ratio of 3 to 20.
